(19) United States
(12) Patent Application Publication
(10) Pub. No.: US 2013/0061942 A1
(43) Pub. Date: Mar. 14, 2013

(54) RESETTABLE RELIEF VALVE

(71) Applicant: DUKES AEROSPACE, INC., Northridge, CA (US)

(72) Inventor: Rex HULSEY, Santa Clarita, CA (US)

(73) Assignee: DUKES AEROSPACE, INC., Northridge, CA (US)

(21) Appl. No.: 13/675,831

(22) Filed: Nov. 13, 2012

Related U.S. Application Data
(63) Continuation of application No. 13/463,577, filed on May 3, 2012.
(60) Provisional application No. 61/482,190, filed on May 3, 2011.

(51) Int. Cl. F16K 17/00

(52) U.S. Cl. 137/15.01; 137/456

(57) ABSTRACT

A resettable relief valve is provided that includes a valve body having a valve seat and forming a pressure chamber, a poppet valve coupled to a poppet shaft slidably received in the valve body, a main spring mounted on the poppet shaft and seated against the valve body for urging the poppet valve into a closed position against the valve seat, and at least one spring loaded ball detent mounted in the valve body to apply pressure against the poppet shaft. A method of resetting a pressure relief valve is also provided, and includes mounting a resettable relief valve so that a pressure chamber of the resettable valve is exposed to a pressurized fluid flow and pushing a poppet valve toward the valve body when the poppet valve is in the open position so that a spring loaded ball detent disengages from a second groove on a poppet shaft and reengages with a first groove.

### CROSS-REFERENCE TO RELATED APPLICATIONS

This application is a Continuation application of U.S. patent application Ser. No. 13/463,577 filed May 3, 2012, which claims priority to U.S. Patent Application Serial No. 61/482,190, filed on May 3, 2011, the disclosure of which is incorporated herein by reference in its entirety.

### FIELD OF THE INVENTION

The disclosure generally relates to pressure relief valves, and, more particularly, to a resettable pressure relief valve.

### BACKGROUND

In aerospace applications, pressure relief valves are critical devices used for many aspects of flight safety. The valves may be mounted to an airframe, for example, to provide pressure relief in fluid lines subject to freezing and/or overpressure, conditions that could potentially result in degraded performance or outright equipment failure. Conventional pressure relief valves, once activated, must be removed from the aircraft and rebuilt or replaced.

A need exists for a pressure relief valve that can be easily reset from the outside of an aircraft, avoiding the cost of downtime for rebuilds and/or replacement inventory.

### BRIEF SUMMARY

The foregoing needs are met by the present disclosure, wherein according to certain embodiments, a resettable relief valve includes a valve body having a valve seat and forming a pressure chamber, a poppet valve coupled to a poppet shaft slidably received in the valve body, a main spring mounted on the poppet shaft and seated against the valve body for urging the poppet valve into a closed position against the valve seat; and at least one spring loaded ball detent mounted in the valve body to apply pressure against the poppet shaft.

In accordance with another embodiment of the present disclosure, a method of resetting a pressure relief valve without disassembly includes the steps of mounting a resettable relief valve so that a pressure chamber of the resettable valve is exposed to a pressurized fluid flow, wherein the resettable relief valve includes a valve body defining the pressure chamber, a poppet valve coupled to a poppet shaft and slidably received in the valve body, wherein the poppet shaft has at least two grooves, a first groove associated with a closed position of the poppet valve and a second groove associated with an open position of the poppet valve, a main spring mounted on the poppet shaft and seated against the valve body for urging the poppet valve into a closed position against the valve seat, and at least one spring loaded ball detent mounted in the valve body to apply pressure against the poppet shaft; and pushing the poppet valve toward the valve body when the poppet valve is in the open position so that the spring loaded ball detent disengages from the second groove on the poppet shaft and reengages with the first groove.

There has thus been outlined, rather broadly, certain aspects of the present disclosure in order that the detailed description herein may be better understood, and in order that the present contribution to the art may be better appreciated.

In this respect, before explaining at least one embodiment of the invention in detail, it is to be understood that the invention is not limited in its application to the details of the construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a resettable relief valve, in accordance with embodiments of the present disclosure;

FIG. 2 is another perspective view of a resettable relief valve, in accordance with embodiments of the present disclosure;

FIG. 3 is a top view of a resettable relief valve, in accordance with embodiments of the present disclosure; and

FIG. 4 is a cross-sectional view of the resettable relief valve of FIG. 3 taken along line A-A, in accordance with embodiments of the present disclosure.

### DETAILED DESCRIPTION

The methods and systems disclosed herein enable a relief valve to be reset when an aircraft is on the ground, without having to remove the valve for a rebuild and/or replace the valve with inventory, generally reducing Aircraft On Ground (AOG) delays, maintenance costs and aircraft downtime. Additionally, the resettable relief valve will not change settings due to aircraft vibration, which minimizes false activations.

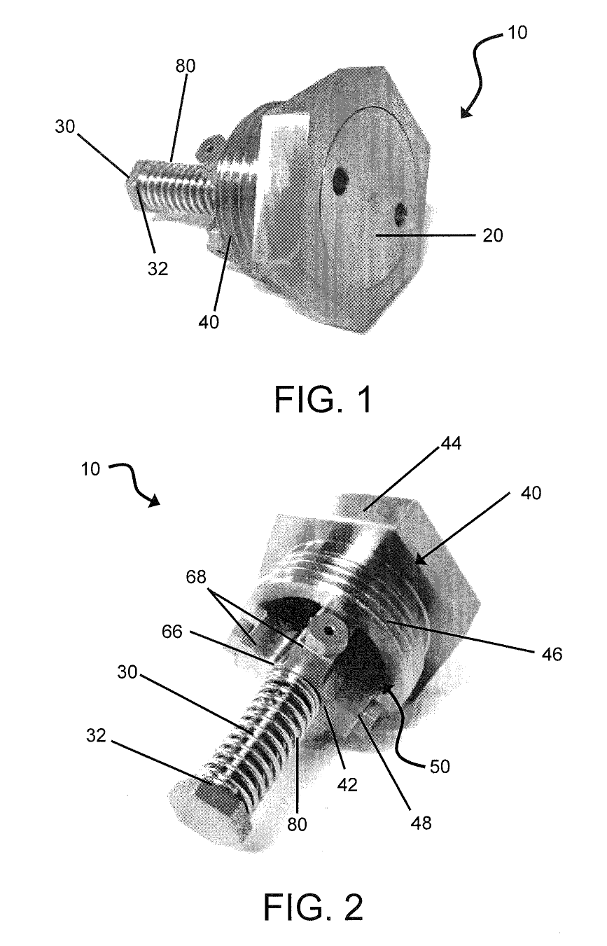

FIGS. 1 and 2 show perspective views of a relief valve 10 according to an embodiment of the present disclosure. The relief valve 10 may be a poppet-type valve assembly that includes a poppet valve 20 mounted on a main shaft 30. The poppet valve 20 and the main shaft 30 are slidably received into a valve body 40 and held in a closed position by at least a compression spring 80 mounted between a detent end 32 of the main shaft 30 and a spring seating surface 42 of the valve body 40.

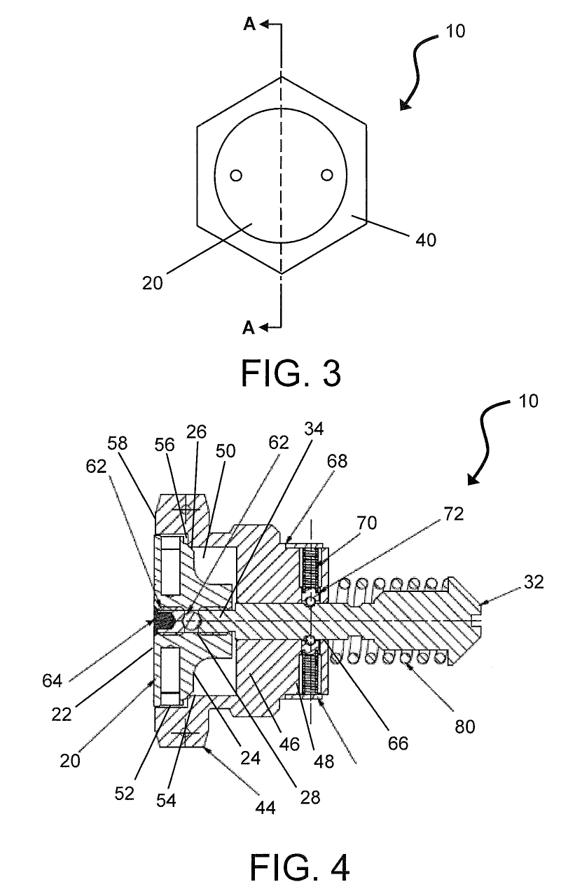

FIG. 3 illustrates a top view of the relief valve 10 and FIG. 4 illustrates a cross-sectional view of the relief valve 10 as viewed along plane A-A of FIG. 3. As shown in FIG. 4, the valve body 40 may include a head section 44, a body section 46 and a spring mount section 48. The valve body 40 may be substantially hollow in order to form a pressure chamber 50 (see also FIG. 2) when the poppet valve 20 is seated in the closed position. For seating the poppet valve 20, a cylindrical first bore 52 having a first diameter may extend into the valve body 40 through the head section 44. A cylindrical second bore 54, having a second diameter smaller than the first diameter, may extend concentrically from the first bore 52 toward the spring mount section 48 to form a valve seat 56. The head section 44 may be formed to hold a tool, such as a wrench, and the body section 46 may be formed with external threading to enable efficient and easy mounting of the relief valve 10.

As shown in FIG. 4, the poppet valve 20 may have a disc-shaped head section 22 that is slidably received into the first bore 52 so that an upper surface 22 of the poppet valve is substantially planar to an upper surface 58 of the head section 44. A lower seating surface 24 of the poppet valve, which may include a tapered or beveled circumferential surface 26, seats the poppet valve 20 against the valve seat 56 to form a fluid-tight seal between the pressure chamber 50 and the environment external to the poppet valve 20 when the relief valve 10 is installed and the poppet valve 20 is held in the closed position.

In accordance with aspects of the disclosure, the end of the shaft 30 opposite of the distal end 32 may be coupled to the poppet valve 20 so the shaft 30 and poppet valve 20 move longitudinally in unison along an axis substantially centered with respect to the shaft 30. A knob 34 may be formed on the end of the shaft 30 to fit into a shaft retaining channel 28 formed in the poppet valve 20. The knob 34 may be press fit into the shaft retaining channel 28 and/or the channel 28 may be internally threaded to receive external threads on the knob 34. In accordance with yet other aspects of the present disclosure, the channel 28 may be formed to allow rotation of the knob 34 therein. To reduce friction and allow rotational movement of the shaft 30 with respect to the poppet valve 20, a ball 60 may be inserted into the channel 28 between the knob 34 of the shaft and a retainer mechanism 62, which may be a plug press fit into the channel 28 or a setscrew having external threads for mating with internal threads formed in the channel 28. An epoxy 64 may be applied for further stabilization of the assembly as well as to ensure an aerodynamic surface is provided external to the relief valve 10 when installed.

As shown in FIG. 2, the spring mount section 48 of the valve body 40 may be formed with a central shaft channel 66 that allows the shaft 30 to extend through the spring mount section 48 and the body section 46 to couple with the poppet valve 20 at or near the head section 44. Individual spring arm supports 68 extend radially from the central shaft channel 66 to form the spring mount section 48 and join the spring mount section with the body section 46. Gaps between the spring arm supports 68 allow fluid communication between the pressure chamber 50 and a fluid environment that is the targeted control environment.

As shown in FIG. 4, each spring arm support 68 may be formed to have a detent channel 70 extending from an external surface of the spring mount section 48 to the central shaft channel 66 substantially orthogonal to the central axis of the shaft 30. A ball detent assembly 72 may be supported in the detent channel 70 along with a compression spring 74. The ball detent assembly 72 may include, for example, a ball and retainer structure. The compression spring 74 may be maintained in a compressed state in the detent channel 70 by a retaining piece 76, such as a press-fit plug or a setscrew, for example. In accordance with yet other aspects of the present invention, the retaining piece 76 may be a retaining ring arc-welded about a circumference of the spring mount section 48, providing closure of the detent channels and a spring seat for the compression spring 74 to exert pressure against the ball detent assembly 72. The ball detent assembly 72 is thus continuously forced against the shaft 30 with a predetermined amount of force, depending on the spring constant of the compression spring 74.

A mating groove 82 may be formed on the shaft 30 to seat the ball detent assembly 72 when the relief valve 10 is in a closed position. Accordingly, when a relief pressure in the pressure chamber 50 exceeds a certain predetermined threshold, the spring loaded ball detent and main spring forces are overcome, and the poppet valve 20 moves to an open position. In the open position, a gap is formed about the periphery of the poppet valve 20, allowing fluid to escape and releasing pressure from the fluid flow path. A second, hold-open groove 84 may be formed on the shaft 30 at a predetermined distance distal to the mating groove 82. When the relief valve 10 is exposed to a relief pressure exceeding the predetermined threshold, and the shaft 30 and poppet valve 20 release to an open position, the hold-open groove 84 may capture the ball detent assemblies 72 to hold open the relief valve 10 until reset. The relief valve 10 may be reset by simply pushing the poppet valve 20 back to the closed position.

In a preferred embodiment, four spring loaded ball detent assemblies 72 are arranged symmetrically around the poppet shaft 30 (e.g., every 90°). In other embodiments, even or odd numbers of spring loaded ball detent assemblies 72 may be arranged symmetrically or asymmetrically around the poppet shaft, such as, for example, three spring loaded ball detent assemblies 72 arranged symmetrically around the poppet shaft 30 (e.g., every 120°).

It is to be understood that any feature described in relation to any one aspect may be used alone, or in combination with other features described, and may also be used in combination with one or more features of any other of the disclosed aspects, or any combination of any other of the disclosed aspects.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A resettable relief valve comprising:
a valve body having a valve seat and forming a pressure chamber;
a poppet valve coupled to a poppet shaft slidably received in the valve body;
a main spring mounted on the poppet shaft and seated against the valve body for urging the poppet valve into a closed position against the valve seat; and
at least one spring loaded ball detent mounted in the valve body to apply pressure against the poppet shaft.

2. The resettable relief valve of claim 1, further comprising:
a mating groove formed on the poppet shaft to receive the spring loaded ball detent.

3. The resettable relief valve of claim 2, further comprising:
a hold-open groove formed on the poppet shaft to receive the spring loaded ball detent and maintain the poppet valve in an open position when the pressure in the pressure chamber exceeds a predetermined threshold.

4. The resettable relief valve of claim 1, wherein the valve body includes a head section, a body section, and a spring mount section.

5. The resettable relief valve of claim 4, wherein the head section includes a cylindrical first bore having a first diameter and a cylindrical second bore having a second diameter smaller than the first diameter for forming the valve seat.

6. The resettable relief valve of claim 5, wherein the poppet valve has a disc-shaped head section that is slidably received into the first bore so that an upper surface of the poppet valve is substantially planar to an upper surface of the head section.

7. The resettable relief valve of claim 6, wherein the poppet valve includes a lower seating surface having a tapered or beveled circumferential surface.

8. The resettable relief valve of claim 4, wherein the spring mount section includes multiple spring arm supports extending radially from a central shaft channel and connected to the body section, the central shaft channel slidably retaining the poppet shaft.

9. The resettable relief valve of claim 8, further comprising:
gaps between the spring arm supports providing fluid communication between the pressure chamber and a targeted fluid environment.

10. The resettable relief valve of claim 8, wherein each spring arm support includes a detent channel extending between an external surface of the spring mount section and the central shaft channel in a direction substantially orthogonal to a central axis of the poppet shaft.

11. The resettable relief valve of claim 10, further comprising:
a compression spring mounted in each detent channel for forcing the spring loaded detent ball against the poppet shaft.

12. The resettable relief valve of claim 11, further comprising:
a retaining device for enclosing the compression spring in the detent channel and providing a spring seat.

13. A method of resetting a pressure relief valve without disassembly, the method comprising the steps of:
mounting a resettable relief valve so that a pressure chamber of the resettable valve is exposed to a pressurized fluid flow, wherein the resettable relief valve comprises:
a valve body defining the pressure chamber;
a poppet valve coupled to a poppet shaft and slidably received in the valve body, wherein the poppet shaft has at least two grooves, a first groove associated with a closed position of the poppet valve and a second groove associated with an open position of the poppet valve;
a main spring mounted on the poppet shaft and seated against the valve body for urging the poppet valve into a closed position against the valve seat; and at least one spring loaded ball detent mounted in the valve body to apply pressure against the poppet shaft; and
pushing the poppet valve toward the valve body when the poppet valve is in the open position so that the spring loaded ball detent disengages from the second groove on the poppet shaft and reengages with the first groove.
